(19) United States
(12) Patent Application Publication
(10) Pub. No.: US 2026/0359087 A1
(43) Pub. Date: Nov. 12, 2026

(54) EDGE ARTIFICIAL INTELLIGENCE EMULATOR ENGINE IN A CLOUD COMPUTING SYSTEM

(71) Applicant: Microsoft Technology Licensing, LLC, Redmond, WA (US)

(72) Inventors: Prasoon PATIDAR, Pittsburgh, PA (US); Alexander Steven Crown, Bellevue, WA (US); Tsu-wang Hsieh, Sammamish, WA (US); Yifei Xu, Los Angeles, CA (US); Tusher Chakraborty, Bellevue, WA (US); Leonardo De Oliveira Nunes, Rio de Janeiro (BR); Ranveer Chandra, Kirkland, WA (US)

(21) Appl. No.: 19/201,783

(22) Filed: May 7, 2025

(51) Int. Cl. G06F 9/455

(52) U.S. Cl. CPC G06F 9/45508

(57) ABSTRACT

Methods, systems, and computer storage media for providing edge artificial intelligence emulation using an edge artificial intelligence emulator engine in an artificial intelligence (AI) system are described. Edge artificial intelligence emulation refers to the set of processes, tools, and frameworks that oversee the configuration, execution, monitoring, and optimization of the edge AI emulation. The edge artificial intelligence emulator engine is designed to help users optimize language model deployments in hybrid edge-cloud environments. Edge artificial intelligence emulator engine via an edge artificial intelligence emulator supports evaluating different language model components, including frameworks, retrieval-augmented generation (RAG) databases, retrievers, cloud backup strategies, and orchestration techniques, to determine the best configuration for a given hardware setup. Edge artificial intelligence emulator engine automates performance trade-off profiles evaluation of various component combinations to optimize edge AI systems. The edge artificial intelligence emulation engine generates an orchestrator and a performance trade-off profile to provide an AI system.

### BACKGROUND

Users rely on edge-cloud environments to enhance performance by processing data locally for low-latency, real-time decision-making, while leveraging the cloud for scalable storage, advanced analytics, and resource-intensive tasks. When data needs to be analyzed at a larger scale or require more computational resources, users can push the data to the cloud. Cloud infrastructure offers powerful computing resources, storage, and advanced analytics that are difficult to achieve with edge devices alone. The edge devices are connected to the cloud either continuously or intermittently, depending on the application. When edge devices reach their processing or storage capacity, they can transmit data to the cloud for further analysis or storage. Cloud-based systems handle more complex tasks, such as running machine learning models, large-scale data analytics, or long-term data storage. Hybrid edge-cloud environments offer a powerful combination of local data processing and centralized cloud services, providing flexibility, scalability, and enhanced performance. They enable users to optimize for latency, reduce bandwidth use, ensure high availability, and leverage advanced analytics, making them ideal for real-time and data-intensive applications across various industries.

### SUMMARY

Various aspects of the technology described herein are generally directed to systems, methods, and computer storage media for, among other things, providing edge artificial intelligence emulation using an edge artificial intelligence emulator engine in an artificial intelligence (AI) system. Edge artificial intelligence emulation refers to the set of processes, tools, and frameworks that oversee the configuration, execution, monitoring, and optimization of the edge AI deployments. The edge artificial intelligence emulator engine is designed to help users optimize language model deployments in hybrid edge-cloud environments. Edge artificial intelligence emulator engine supports evaluating different language model components, including frameworks, retrieval-augmented generation (RAG) databases, retrievers, cloud backup strategies, and orchestration techniques, to determine the best configuration for a given hardware setup. Edge artificial intelligence emulator engine automates the accuracy, latency, and cost evaluation of various component combinations, reducing the time-consuming and manual process of optimizing edge AI systems.

In operation, an input is accessed at an artificial intelligence emulator. The input is associated with generating an orchestrator. The input defines a custom artificial intelligence system configuration profile for an artificial intelligence system. Based on the custom artificial intelligence system configuration profiles, interactions of a hybrid edge-cloud computing environment are simulated. The interactions are associated with functionality of the artificial intelligence system. Based on simulating the interactions, an orchestrator for executing queries associated with the artificial intelligence system is generated. The orchestrator supports generating optimal query resolution paths for the queries.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1A-1E are edge artificial intelligence emulation schematics associated with an edge artificial intelligence emulation architecture and workflow of an edge artificial intelligence emulator engine, in accordance with aspects of the technology described herein;

FIG. 2A is a block diagram of an exemplary AI system including an edge artificial intelligence emulator engine, in accordance with aspects of the technology described herein;

FIG. 2B is a flow diagram associated with an exemplary AI system including an edge artificial intelligence emulator engine, in accordance with aspects of the technology described herein;

FIG. 3 provides a first exemplary method of providing edge artificial intelligence emulation using an edge artificial intelligence emulator engine, in accordance with aspects of the technology described herein;

FIG. 4 provides a second exemplary method of providing edge artificial intelligence emulation using an edge artificial intelligence emulator engine, in accordance with aspects of the technology described herein;

FIG. 5 provides a third exemplary method of providing edge artificial intelligence emulation using an edge artificial intelligence emulator engine, in accordance with aspects of the technology described herein;

FIG. 6 provides a block diagram of an exemplary computing system suitable for use in implementing aspects of the technology described herein;

FIG. 7 provides a block diagram of an exemplary distributed computing environment suitable for use in implementing aspects of the technology described herein; and

FIG. 8 provides a block diagram of an exemplary computing environment suitable for use in implementing aspects of the technology described herein.

### DETAILED DESCRIPTION

### Overview

An edge-cloud computing system combines the power of edge computing and cloud computing to enhance performance, reduce latency, and improve scalability. In such a system, computation is distributed between edge devices (e.g., sensors, IoT devices, and local gateways) and remote cloud servers. Edge devices process data locally, handling tasks such as data filtering, preprocessing, and real-time analytics. This minimizes the need to transmit large volumes of raw data to the cloud, reducing network bandwidth usage and latency. Edge devices can also make autonomous decisions based on the processed data, enabling faster response times for critical applications. The cloud component provides centralized, high-performance resources for tasks requiring more computational power, such as complex analytics, long-term data storage, and training machine learning models. It serves as a backup and orchestration layer, ensuring that data is synchronized, aggregated, and managed at scale.

This hybrid architecture allows for optimal resource utilization: edge devices handle real-time, low-latency tasks, while the cloud manages intensive, large-scale computing. Communication between edge and cloud nodes is typically facilitated via low-latency networks, such as 5G or private fiber, ensuring seamless data flow and coordination between local and remote resources. This setup is ideal for applications in IoT, autonomous systems, and smart cities.

AI implementation in edge-cloud computing involves distributing artificial intelligence tasks across both edge devices and cloud resources to optimize performance, reduce latency, and enhance scalability. In this system, edge devices such as IoT sensors, cameras, or gateways run lightweight AI models for real-time processing and decision-making. These models can perform tasks like object detection, anomaly detection, or predictive maintenance directly on the edge, ensuring quick responses without relying on centralized cloud servers.

The edge devices handle low-latency tasks by processing data locally, reducing the need for constant communication with the cloud and thereby minimizing bandwidth usage. For instance, edge-based AI can filter and preprocess data, transmitting only relevant or aggregated information to the cloud.

Meanwhile, the cloud serves as a centralized hub for more resource-intensive AI workloads, such as training complex machine learning models or running large-scale data analytics. The cloud can also update AI models on the edge devices periodically, ensuring they are continually improving without requiring frequent manual intervention.

The integration of AI in edge-cloud computing allows for faster decision-making at the edge, with cloud resources providing the power needed for model training and long-term data analysis. This architecture is especially beneficial for applications like autonomous vehicles, smart cities, and industrial IoT, where real-time and scalable AI capabilities are essential.

Conventionally edge-cloud AI systems are not configured with a comprehensive computing logic and infrastructure to provide optimized language model deployments in hybrid edge-cloud environments. Traditional hybrid-edge computing systems suffer from several key limitations. Most tools focus on optimizing components in isolation rather than evaluating the entire end-to-end inference pipeline. For instance, some solutions optimize only the orchestration between edge and cloud, while others focus solely on language model performance without considering retrieval strategies, database selection, or overall system efficiency. This narrow focus prevents users from getting a holistic view of how different system components interact, leading to suboptimal configurations.

Another major limitation is the lack of automation in configuration selection. Many existing approaches require users to manually test multiple combinations of models, databases, and hardware settings, making the process time-consuming, complex, and resource intensive. Furthermore, most solutions do not efficiently handle trade-offs between accuracy, cost, and latency, forcing users to navigate these decisions without clear optimization guidance. Additionally, they often lack pluggability, meaning users cannot easily integrate custom models, retrieval methods, or databases into the system. Finally, real-world constraints, such as network stability, hardware accelerators, and domain-specific knowledge, are frequently overlooked, limiting adaptability for diverse applications. Without a comprehensive, automated, and modular approach, these existing solutions fail to provide a streamlined and efficient way to optimize AI-powered edge deployments.

By way of example, a healthcare provider deploying an AI assistant for real-time medical query resolution faces major challenges with existing solutions. Their edge devices have limited GPU power, and network stability is inconsistent, making cloud-based inference unreliable. Existing tools force them to manually test various model, database, and retriever configurations, consuming significant time and resources. Furthermore, they cannot easily integrate domain-specific medical knowledge bases, reducing the AI's accuracy. Without a holistic optimization framework, they struggle to balance latency, cost, and accuracy, leading to inefficient deployments that either overload the edge device or suffer from high cloud-compute expenses and slow response times. As such, a more comprehensive AI system-with an alternative basis for performing edge artificial intelligence emulation-can improve computing operations and interfaces for artificial intelligence systems.

### Description of Technical Solution

At a high level, the edge artificial intelligence emulator engine is designed to optimize language model deployments in hybrid edge-cloud environments. As generative AI adoption grows, organizations face challenges in selecting the best models, retrieval methods, and inference configurations that balance accuracy, cost, and latency. The edge artificial intelligence emulator engine streamlines this process by providing an automated evaluation framework that analyzes multiple configurations, identifying the pareto-optimal solutions tailored to a user's hardware and network conditions.

The edge artificial intelligence emulator engine serves as the core computational framework responsible for executing the AI-driven decision-making processes that optimize query resolution. The edge artificial intelligence emulator engine integrates query preprocessing, retrieval-augmented generation (RAG), model selection, and real-time response evaluation into a cohesive pipeline. The edge artificial intelligence emulator engine leverages heuristic optimization, clustering techniques, and unsupervised learning to identify the most efficient query resolution path dynamically. By continuously monitoring latency, cost, and accuracy trade-offs, the edge artificial intelligence emulator engine adapts execution strategies in real-time, ensuring optimal performance in hybrid edge-cloud AI environments.

The edge artificial intelligence emulator engine also includes an edge artificial intelligence emulator that functions as an evaluation and benchmarking system that tests and simulates different query execution strategies before live deployment. The edge artificial intelligence emulator provides offline benchmarking for model selection, retrieval strategies, and inference configurations, allowing users to assess cost-efficiency, response accuracy, and computational resource consumption under various conditions. The edge artificial intelligence emulator generates an orchestrator, and a performance trade-off profiles (e.g., Accuracy/Cost/Latency Profile) which serves as a historical performance reference for optimizing query handling. Additionally, it integrates concept drift detection, ensuring that retrieval and inference models evolve alongside changing user behavior and query distributions.

The edge artificial intelligence emulator engine includes the orchestrator operates that operates as a real-time decision-making module, dynamically selecting and executing the most efficient query processing pipeline based on system constraints and predefined objectives. Unlike the emulator, which focuses on offline evaluations, the orchestrator makes instantaneous routing decisions, determining whether a query should be processed locally (on edge devices) or offloaded to cloud resources. It incorporates real-time feedback, live system load balancing, and adaptive model switching, ensuring optimal AI execution in dynamic environments. Furthermore, the orchestrator manages multi-hop retrieval, integrates safety and compliance guardrails, and ensures context-aware query resolution by leveraging domain-specific knowledge sources.

Operationally, the edge artificial intelligence emulator engine integrates retrieval-augmented generation (RAG), LLM orchestration, and modular AI evaluation tools, enabling users to dynamically optimize their query resolution process. Unlike existing solutions that focus on isolated components (e.g., context retriever, model selector), the edge artificial intelligence emulator engine offers end-to-end optimization, considering the entire AI inference pipeline from preprocessing to response evaluation. By leveraging modular components, pluggable architectures, and orchestrator-driven decision-making, the edge artificial intelligence emulator engine provides a scalable, adaptable, and future-proof solution for developers, AI researchers, and enterprises deploying language models in real-world, resource-constrained environments.

The edge artificial intelligence emulator engine is designed with principles to optimize AI inference across edge and cloud environments. One of its objectives is to balance accuracy, cost, and latency, ensuring that users can select an optimal configuration that aligns with their specific business or research needs. AI applications often require a trade-off between high inference accuracy, fast response times, and operational costs. The edge artificial intelligence emulator engine evaluates various query resolution paths and automatically filters out suboptimal configurations, reducing the search space and presenting only the best-performing setups, thereby simplifying the decision-making process for users.

The edge artificial intelligence emulator engine provides support for both edge and cloud-based AI inference, offering flexibility depending on the user's hardware and network conditions. Edge devices provide low-latency, offline inference, while cloud-based models offer greater computational power and improved accuracy. The edge artificial intelligence emulator engine dynamically switches between edge and cloud processing based on device constraints and network availability, ensuring seamless deployment across IoT devices, mobile applications, and enterprise cloud environments. This adaptability enables organizations to optimize AI workflows without being restricted to a single infrastructure.

The edge artificial intelligence emulator engine is built with a modular and pluggable architecture that allows users to integrate custom models, retrieval mechanisms, and databases. By defining common interfaces for essential system components such as LLM frameworks, retrievers, evaluators, and orchestrators, it ensures that upgrades and customizations can be implemented seamlessly. As AI models evolve, the edge artificial intelligence emulator engine can be extended without requiring a complete system overhaul, making it a future-proof solution for AI-driven applications.

Rather than relying on manual configuration, the edge artificial intelligence emulator engine employs an edge artificial intelligence emulator that automates orchestration and configuration selection. Typically, optimizing AI inference requires users to manually test multiple combinations of LLMs, databases, and retrieval strategies. The edge artificial intelligence emulator engine eliminates this complexity by dynamically selecting the best query resolution strategy, taking into account trade-offs between accuracy, speed, compute availability on edge devices, and cost constraints for cloud inference. This automation significantly reduces deployment time and improves efficiency, allowing users to focus on results rather than technical fine-tuning.

Most existing AI optimization solutions focus on narrow aspects of the inference pipeline, such as optimizing the connection between cloud and edge devices or benchmarking single models. In contrast, the edge artificial intelligence emulator engine evaluates the entire end-to-end system, including retrievers, databases, models, and orchestration. It not only automates search space reduction by filtering out ineffective configurations but also provides hybrid deployment support by evaluating both edge-based and cloud-based models. Unlike conventional tools that offer limited flexibility, the edge artificial intelligence emulator engine's custom pluggable architecture allows users to integrate their own models, retrieval methods, and evaluation criteria. Additionally, its intelligent orchestrator dynamically selects the best query path, whereas traditional solutions typically lack such optimization. By addressing the full scope of AI inference management, the edge artificial intelligence emulator engine provides a comprehensive and scalable solution that enhances both performance and efficiency.

By way of illustration, the edge artificial intelligence emulator engine begins by processing input that defines a custom artificial intelligence configuration profile that includes accuracy, cost, and latency constraints, domain contexts, and device configuration. When a query is submitted, the emulator refines and preprocesses it through query enhancement techniques such as keyword expansion or reformatting. This step ensures that the query is structured in a way that maximizes the relevance of retrieved information.

To determine the most effective inference path, the emulator dynamically chooses between running models locally on edge devices or offloading inference to the cloud. If the device has sufficient computational power and low latency is a priority, the system executes the model on-device (e.g., Ollama, an edge-based framework optimized for efficient LLM inference). If higher accuracy is required or the edge device lacks sufficient resources, the query is processed in the cloud using (e.g., GPT-4) leveraging scalable computational power.

The edge artificial intelligence emulator engine integrates advanced retrieval mechanisms that stores and retrieves query-relevant documents using vector databases such as ChromaDB. When a query is received, the retriever searches these databases for semantically similar documents and extracts the most relevant context to enhance the model's response accuracy. This process ensures that responses are informed by domain-specific knowledge rather than relying solely on the LLM's internal representations. The emulator also refines retrieved content by filtering out irrelevant or redundant data, reducing unnecessary computational overhead while improving response quality.

Once the inference is complete, the emulator evaluates the model's output using a structured assessment framework. The response undergoes quality checks based on accuracy, fluency, coherence, and relevance, utilizing tools such as DeepEval to measure performance. By applying these evaluation criteria, the edge artificial intelligence emulator engine determines whether the generated response meets the user's specified constraints. If a response is found lacking, the emulator may adjust retrieval parameters, reprocess the query with a different model, or modify the query resolution path to optimize results.

A key advantage of the edge artificial intelligence emulator engine is its modular and pluggable architecture, which allows users to customize and extend the system with additional models, retrievers, and evaluators. The emulator defines common interfaces for database connections, inference frameworks, and logging modules, enabling seamless integration of third-party solutions. This extensibility ensures that the system remains adaptable to new AI advancements and retrieval techniques, allowing organizations to future-proof their deployments without requiring extensive modifications.

The edge artificial intelligence emulator performance insights are used to generate or are used in an orchestrator. The orchestrator is a real-time decision-making engine responsible for dynamically selecting the most efficient query resolution path based on accuracy, latency, and cost constraints. The orchestrator acts as the core optimization layer, ensuring that user queries are processed using the most effective retrieval, model selection, and inference execution strategy while continuously adapting to real-time system conditions.

Upon receiving a query, the orchestrator evaluates multiple factors, including query complexity, user intent, output format, and system constraints. The orchestrator determines whether the query should be processed locally on an edge device using a lightweight Edge LLM or offloaded to a cloud-based LLM for more complex computations. This decision is made dynamically, balancing response speed, computational efficiency, and cloud processing costs. The orchestrator leverages multi-tiered retrieval strategies to fetch relevant context before inference. It dynamically selects the best Retrieval-Augmented Generation (RAG) method, determining whether a single-hop or multi-hop retrieval approach is necessary. This ensures that responses are enriched with domain-specific context, improving relevance and factual accuracy.

The orchestrator supports real-time feedback and path-switching capability. If an inference path fails to meet latency or accuracy requirements, the orchestrator automatically reroutes the query to an alternative processing route, such as a different model, retrieval method, or execution framework. It also incorporates guardrails for safety and compliance, applying filtering mechanisms to enforce ethical AI standards and regulatory requirements.

Additionally, the orchestrator integrates concept drift awareness by continuously monitoring user behavior, query patterns, and system performance metrics, ensuring that AI-driven responses remain adaptive to evolving requirements. Through its ability to dynamically orchestrate AI workflows, the orchestrator delivers a scalable, intelligent, and cost-efficient solution for managing AI inference in hybrid edge-cloud environments.

In this way, the edge artificial intelligence emulator engine streamlines the process of deploying and optimizing AI inference in edge-cloud environments. It eliminates the need for extensive manual configuration by dynamically selecting the best query resolution strategy, reducing operational complexity, and ensuring efficient performance tailored to user needs. Through intelligent decision-making, modular design, and adaptive inference selection, the emulator delivers an advanced technical solution for organizations looking to maximize the efficiency of language model deployments.

### Example Systems and Resources

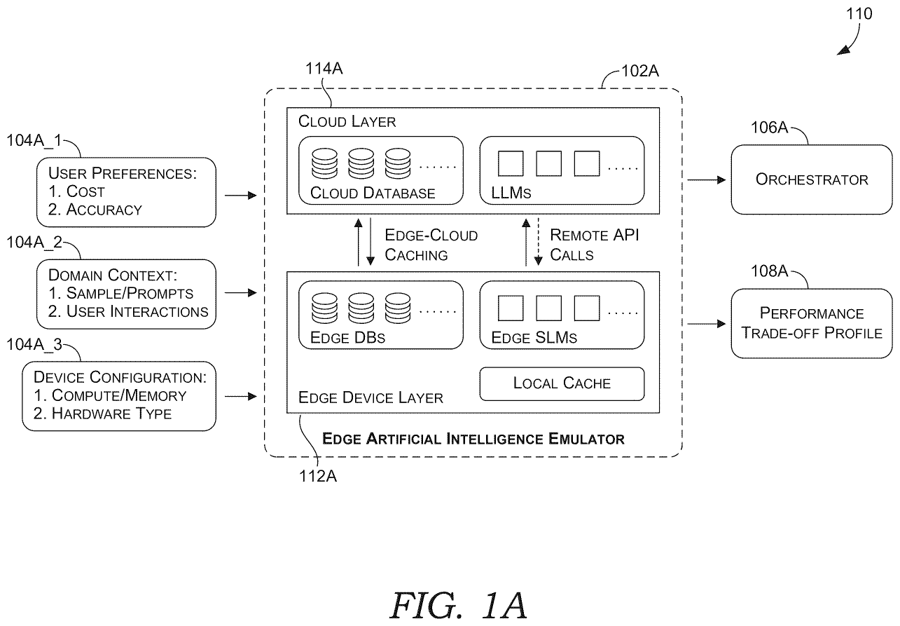

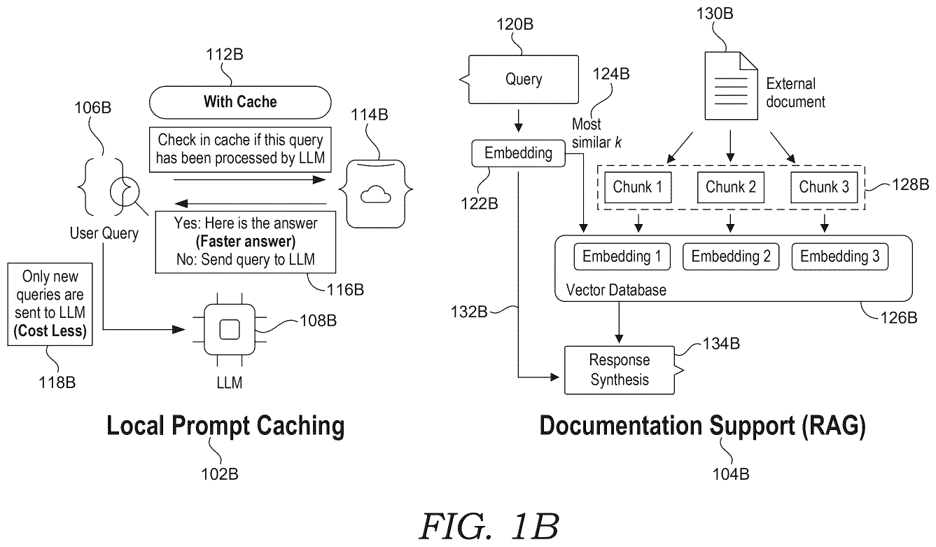

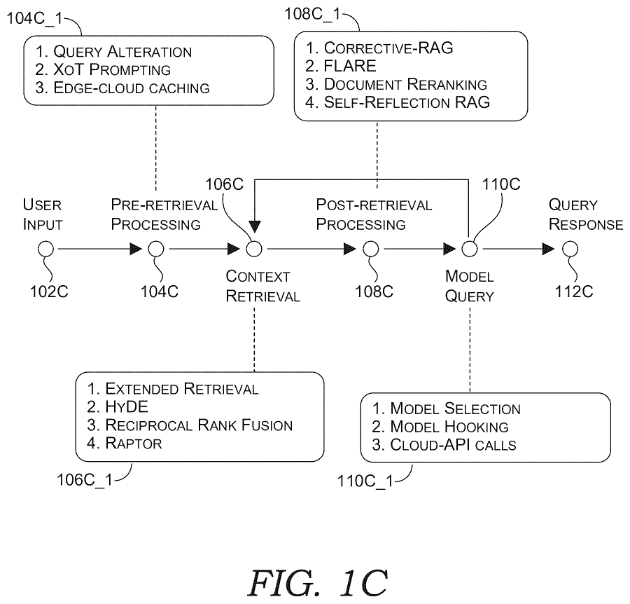

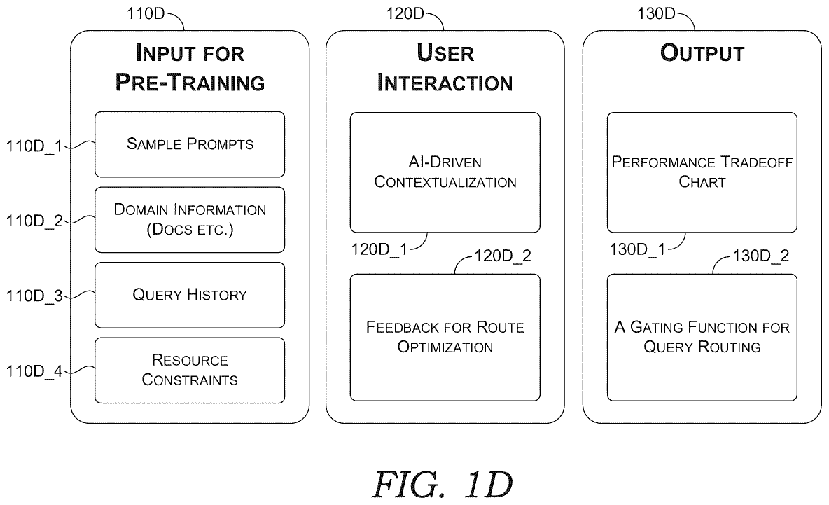

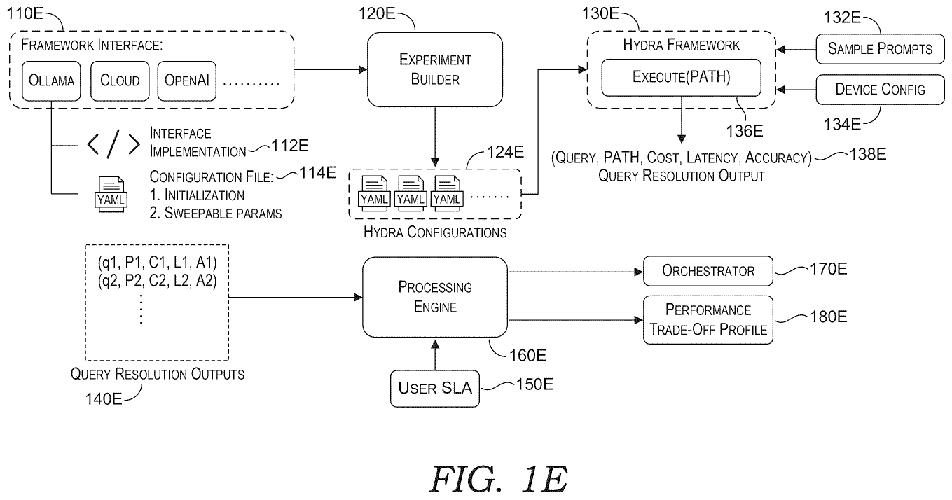

Aspects of the technical solution can be described by way of examples and with reference to FIG. 1A-1E, 2A, and 2B. With reference to FIG. 1A, FIG. 1A illustrates a schematic associated with providing edge artificial intelligence emulation using an edge artificial intelligence emulator engine 110 for a hybrid edge-cloud artificial intelligence (AI) deployment. The edge artificial intelligence emulator engine 110 functions as an intelligent query resolution system that dynamically orchestrates computational resources across edge devices and cloud servers to optimize inference efficiency. The edge artificial intelligence emulator engine 110 outputs query orchestrators based on hardware capabilities, network conditions, and user-defined performance criteria to ensure low-latency, cost-efficient, and high-accuracy responses.

The edge artificial intelligence emulator 102A ingests three primary input categories to determine the optimal query resolution strategy. User preferences 104A_1 or User SLA (Service Level Agreement) define the operational trade-offs, specifying accuracy thresholds, latency constraints, and cost considerations. Domain context 104A_2 or information includes contextual knowledge such as specialized data repositories, retrieval-augmented generation (RAG) models, or rule-based decision frameworks, ensuring that query resolution aligns with domain-specific requirements. Device configuration 104A_3 or constraints encapsulate hardware limitations, including available compute resources (CPU, GPU, or NPU), memory capacity, and network bandwidth stability, which directly impact whether inference is executed locally or offloaded to the cloud.

Based on these inputs, the edge artificial intelligence emulator 102 generates two core outputs: an orchestrator 106A and a performance trade-off profile 108A. Generating these outputs can refer to the generating a performance insight produced by the edge artificial intelligence emulator 102 to optimize real-time decision-making via the orchestrator 106A. The orchestrator 106A is a decision-making engine that constructs an optimal query execution pipeline, selecting the most efficient combination of retrieval mechanisms, model invocation strategies, and computational distribution between edge and cloud environments. The performance trade-off profile provides a quantitative evaluation of different query resolution pathways, highlighting trade-offs in accuracy, cost, and latency. This systematic evaluation allows users to select configurations that best align with their operational and deployment objectives while minimizing manual intervention and computational inefficiencies.

As shown in FIG. 1A, the edge artificial intelligence emulator engine 110 processes user inputs, leverages computational resources across edge and cloud environments, and generates optimized query resolution strategies. The three user input categories are depicted: User SLA 104A_1 or user preferences-defines performance requirements, for example, cost constraints and accuracy expectations; domain context 104A_2—represents the domain-specific data, such as sample prompts and user interaction history, that informs the retrieval and inference process; and device configuration 104A_3—includes hardware-specific details like compute and memory capacity, as well as the type of accelerators (CPU/GPU/NPU) available for processing.

The edge artificial intelligence emulator engine 110 is divided into two primary layers: edge device layer 112A—includes local databases (edge DBs) and edge-based small language models (edge SLMs) that utilize local caching to enhance performance. Queries can be resolved locally if the edge device has sufficient compute power; cloud layer 114A—includes cloud-hosted databases and large language models (LLMs) that process queries when local resources are insufficient. The system performs remote APIs calls and edge-cloud caching to optimize response retrieval and minimize latency. As shown, bidirectional interactions between edge device layer 112A and cloud layer 114A enable dynamic workload distribution. Queries can be processed locally, cached for reuse, or escalated to cloud-based inference models when greater accuracy or computational power is needed.

The edge artificial intelligence emulator 102A generates two outputs: an orchestrator 106A that is responsible for dynamically selecting the optimal query execution path based on user constraints and edge artificial intelligence emulator engine conditions. Performance tradeoff profile 108A (i.e., accuracy, cost, latency) is a performance report that quantifies the trade-offs between accuracy, computational cost, and inference latency, helping users refine deployment strategies. Overall, FIG. 1A illustrates how the edge artificial intelligence emulator engine integrates query resolution, retrieval, and inference selection to deliver efficient AI-driven processing across distributed environments.

An edge artificial intelligence emulator engine architecture of the edge artificial intelligence emulator engine can generate an orchestrator output that provides optimal language model inferencing in edge-cloud environments by intelligently managing query resolution, retrieval, model selection, and evaluation. The edge artificial intelligence emulator engine includes processors, databases, retrievers, frameworks, and evaluators that support the functionality of the edge artificial intelligence emulator engine.

The processor is responsible for improving user queries by adding more information, changing question style, or splitting queries. For example, a processor can add keyword, synonyms or paraphrases to a query to make it more specific. This facilitates narrowing the search space and increasing the chances of finding a relevant answer.

The database connects to different types of vector databases that store and retrieve documents based on their similarities to a query. An edge-based database can specifically be employed to connect to cloud-based databases using endpoints.

The retriever is responsible for extracting context information for a query from a database. The context information can be domain-specific data, models or rules that can help answer the query. The edge artificial intelligence emulator engine can support a single database that can have multiple collections of documents. A collection is a group of documents that share a common topic or theme.

The framework invokes a language model for a query. A language model can refer to any tool that can generate natural language responses for a query. The frameworks can switch between different models that are deployed on the edge device or on the cloud server. The edge artificial intelligence emulator engine can be implemented with edge-based models and cloud-based models.

With reference to FIG. 1B, FIG. 1B two example features of the orchestrator local prompt caching 102B and RAG-based documentation support 104B-that the orchestrator employs to optimizes AI-driven query processing, balancing speed, accuracy, and resource efficiency in hybrid edge-cloud environments. Local prompt caching 102B is an optimization technique that reduces redundant query processing by storing previously generated responses and reusing them for identical or semantically similar queries. The orchestrator employs local prompt caching to minimize latency, cost, and computational overhead, particularly for frequently asked queries or repetitive prompts. For example, the orchestrator first checks the local cache before sending a query for inference. If a match is found, the cached response is retrieved instantly, eliminating the need for reprocessing. If no cached result exists, the query is sent to an edge or cloud LLM, and the response is stored for future retrieval, ensuring faster execution and lower processing costs.

Documentation support via RAG enhances AI-generated responses by integrating external domain knowledge. The orchestrator employs RAG to dynamically retrieve relevant documents from vector databases, selecting the most contextually appropriate chunks to inform inference. This ensures that the AI model generates responses grounded in accurate, external data, improving factual correctness. The orchestrator may also dynamically adjust retrieval depth, deciding whether a single-hop or multi-hop retrieval approach is required based on query complexity.

As shown in FIG. 1B, the local prompt caching 102B is associated with user query 106B that is received, and the orchestrator first checks 112B the local cache 114B to determine if an identical or semantically similar query has already been processed by the LLM (Large Language Model). If a matching response exists in the local cache 114B, the orchestrator bypasses model inference and returns 116B the cached response immediately, ensuring a faster answer with lower resource consumption. If the user query 106B is new or has not been processed before, it is sent 118B to the LLM 108B for inference, generating a new response. Once processed, the response is stored in the cache for future reference. This caching mechanism ensures that only new queries are routed to the LLM 108B, significantly reducing inference costs and optimizing query resolution efficiency.

FIG. 1B also illustrates RAG-based documentation support 104B that is associated with a query 120B that is submitted, and then, first converted into an embedding 122B, a numerical vector representation that captures the semantic meaning of the input. The orchestrator then searches 124B a vector database 126B for the most similar k embeddings, identifying relevant context from pre-indexed document chunks 128B. These documents (e.g., external documents 130B) have been preprocessed and stored in segmented chunks (Chunk 1, Chunk 2, Chunk 3), each converted into embeddings to allow for efficient semantic similarity retrieval. The orchestrator then retrieves the most relevant document chunks, which provide domain-specific knowledge, and forwards 132B them for response synthesis 134B to ensure that the final output is grounded in retrieved facts, reducing hallucination and enhancing response accuracy.

With reference to FIG. 1C, FIG. 1C illustrates the query resolution path within the edge artificial intelligence emulator engine, demonstrating the modular and configurable nature of query processing. FIG. 1C outlines the sequential steps involved in transforming a user query into a final response, while also showcasing various processing techniques that can be selectively applied at each stage to optimize accuracy, cost, and latency.

As shown, the process begins with user input 102C, which serves as the raw query provided by the user. User input 102C is then subjected to pre-retrieval processing 104C where pre-retrieval processing techniques 104C_1 (e.g., query alteration, XoT prompting, and edge-cloud caching) can be applied. Pre-retrieval processing techniques 104C_1 facilitate refining the query before retrieval, potentially improving relevance and efficiency in subsequent steps.

At context retrieval 106C involves fetching relevant documents or knowledge from databases. The edge artificial intelligence emulator engine employs different retrieval strategies 106_1 (e.g., Extended Retrieval, Hypothetical Document Embeddings (HyDE), Reciprocal Rank Fusion, and Raptor) to identify and extract the most relevant contextual information. These approaches enhance the query with additional information that improves response quality.

Following context retrieval 106C, the edge artificial intelligence emulator engine applies post-retrieval processing 108C, which further refines the retrieved context before passing it to the language model. Post-retrieval processing 108C includes post-retrieval processing techniques 108C_1 (e.g., Corrective-RAG (Retrieval-Augmented Generation), FLARE, document reranking, and self-reflection RAG) each of which contributes to improving the relevance and coherence of retrieved content. Post-retrieval processing 108C ensures that the model receives the highest-quality contextual information for generating an accurate and useful response.

Once post-retrieval adjustments are complete, the query is forwarded to the model query 110C stage. At this point, the edge artificial intelligence emulator engine determines the best inference strategy by using model integration operations 110C_1 (e.g., selecting an appropriate model, hooking into specific processing frameworks, and making cloud-based API calls if necessary). The model from the model query 110C then generates a response based on the refined query and retrieved context.

Finally, the query response 112C stage delivers the optimized response to the user. The various modules create a large search space of possible resolution paths, each combining different techniques at different stages. This flexible architecture allows the edge artificial intelligence emulator engine to dynamically select the most effective processing pipeline based on user constraints, hardware capabilities, and query complexity. Each processing element is developed and cataloged as an independent module within the corresponding module manager, ensuring modularity and extensibility. This approach enables continuous improvements in retrieval, inference, and orchestration while allowing users to integrate custom processing techniques to meet domain-specific needs.

With reference to FIG. 1D, FIG. 1D illustrates features of the edge artificial intelligence emulator engine learning and optimization process, segmented into three main categories: input for pretraining, user interactions, and emulator outputs. Each category represents a critical aspect of how the system is trained, refined, and utilized for efficient query resolution.

The input for pretraining 110D section outlines the foundational data sources used to prepare the emulator for effective operation. This includes sample prompts 110D_1, which help structure and guide the model's responses, domain information 110D_2 such as documents and specialized knowledge bases, query history 110D_3 that captures past interactions for learning patterns, and resource constraints 110D_4, which define hardware limitations, network bandwidth, and computational availability.

The user interactions 120D section represents real-time engagement with the system, allowing for dynamic adjustments based on feedback. This includes AI-driven contextualization 120D_1, where the emulator refines its understanding of queries based on past responses and evolving context. Additionally, feedback for route optimization 120D_2 helps improve how queries are processed by analyzing user interactions and system performance over time.

The emulator outputs 130D section highlights the results generated by the system. One output is a performance trade-off profile chart 130D_1 (e.g., accuracy/latency tradeoff chart) which visualizes the performance impact of different inference configurations, helping users balance precision with computational efficiency. Another key output is a gating function for query routing 130D_1, which dynamically determines the most effective execution path based on pre-defined constraints such as cost, accuracy, and response time.

The structured workflow where pretraining inputs establish the emulator's capabilities, user interactions refine its performance, and outputs provide actionable insights to optimize query resolution. This architecture ensures that the emulator continuously adapts to varying requirements while maintaining efficiency in hybrid edge-cloud AI environments.

With reference to FIG. 1E, FIG. 1E illustrates an edge artificial intelligence emulator engine workflow for optimizing query resolution by selecting and retrieval strategies, inference models, and execution paths across hybrid edge-cloud environments. The framework interface 110E connects to multiple AI inference models, including Ollama, Azure Cloud, and OpenAI, allowing the system to dynamically select between local or cloud-based inference depending on computational and latency constraints.

The interface implementation 112E ensures seamless interaction between the framework interface and execution pipeline, translating structured queries into model-compatible formats. The configuration file 114E defines initialization parameters and sweep-able configurations, enabling automated experimentation across different query resolution strategies. Sweep-able configurations can refer to sets of parameters that can be automatically varied and tested during system evaluation to identify the optimal setup for a task. Sweep-able configurations may include factors like model selection, retrieval strategies, prompting methods, and resource constraints, and they enable automated experimentation for dynamic system optimization by benchmarking performance metrics.

The experiment builder 120E evaluates multiple execution paths to determine the most efficient strategy, leveraging structured Hydra configurations 124E to systematically explore different query resolutions. The experiment builder 120E connects to the Hydra framework 130E, which executes different query resolution paths while analyzing trade-offs between accuracy, cost, and latency. The Execute (PATH) module 136E within the Hydra framework runs multiple configurations, logs performance metrics, and benchmarks execution strategies for optimization. The query resolution output (138E) contains benchmarked performance data, helping determine the best query processing strategy for the orchestrator.

The experiment builder 120E also processes external inputs such as sample prompts 132E to test models against predefined interaction scenarios and device configurations 134E to account for hardware constraints, such as compute limitations and memory availability.

The query resolution outputs 140E generated by the processing engine serve as real-time inference results, optimized based on the experimental findings of the emulator. The processing engine 160E executes query resolution outputs while adhering to user-defined SLA constraints 150E, ensuring accuracy thresholds, cost limitations, and acceptable latency levels are met. The processing engine generates the orchestrator 170E that serves as the system's real-time execution module, dynamically selecting the best query resolution path by integrating performance insights produced by the emulator. The orchestrator 170E ensures dynamic model selection, determining whether a query should be processed locally using an edge-based language model (Edge LLM) or offloaded to a cloud-based LLM for more complex computations. The performance trade-off profile 180E (e.g., accuracy/cost/latency profile) functions as a historical benchmarking database, continuously updating based on previous executions, allowing the orchestrator to make informed routing decisions over time.

By way of example, a retail chain implements the edge artificial intelligence emulator to emulate an AI-driven customer support assistant across smart kiosks in physical stores and a cloud-based mobile app. The edge artificial intelligence emulator, functioning as an offline evaluation system, benchmarks multiple query resolution strategies, allowing the retailer to optimize the AI system in real-time execution based on its specific use case.

An example user interacts with a store kiosk and submits the following query: “Do you have wireless noise-canceling headphones under $200 in stock?” The framework interface 110E determines which AI inference model should be used for the evaluating whether an edge LLM is sufficient or if cloud LLM processing is necessary. The interface implementation 112E translates the natural language query into a structured format, making it compatible with the selected AI model. The configuration file 114E defines multiple sweep-able parameters that the emulator will evaluate, allowing the retailer to test different configurations before deploying them in a live AI system.

The experiment builder 120E systematically evaluates various execution strategies to determine the best approach for this specific AI system use case. It leverages Hydra configurations 124E to run structured tests across multiple resolution paths. The Hydra framework 130E, acting as the experimentation engine, executes different query resolution paths, testing variations such as retrieving stock data from the edge database, querying cloud-based inventory, or using a hybrid approach.

The Execute (PATH) module 136E runs multiple execution strategies, logging performance metrics such as query latency, retrieval accuracy, and cloud processing cost to determine the optimal resolution path. The query resolution output 138E records the outcomes of the evaluations, ensuring that the best strategies are identified before deploying them in the live AI system.

The experiment builder 120E incorporates external inputs, such as sample prompts 132E and device configurations 134E, ensuring that the evaluation considers the unique constraints of each edge device type, network limitations, and compute power. The processing engine 160E simulates real-time query processing based on user SLA constraints 150E, ensuring that different execution paths are tested under realistic conditions before deployment. The query resolution outputs 140E generated by the emulator provide insights into whether the edge LLM can handle queries autonomously or if cloud augmentation is needed for certain conditions. The orchestrator 170E from the emulator can employ the insights generated by the emulator to make real-time query resolution decisions in a live setting. The performance trade-off profile 180E generated by the emulator serves as a benchmarking database that informs the orchestrator, enabling it to select the best execution strategy based on tested scenarios rather than relying on trial-and-error in a live environment.

Once deployed, orchestrator 170E will use these findings to determine the most cost-effective, latency-optimized, and accurate execution path for real-time customer interactions. If a user submits the same query in the live system, the orchestrator will leverage the emulator's evaluation results to immediately determine the best processing route, ensuring optimal performance without unnecessary cloud processing costs.

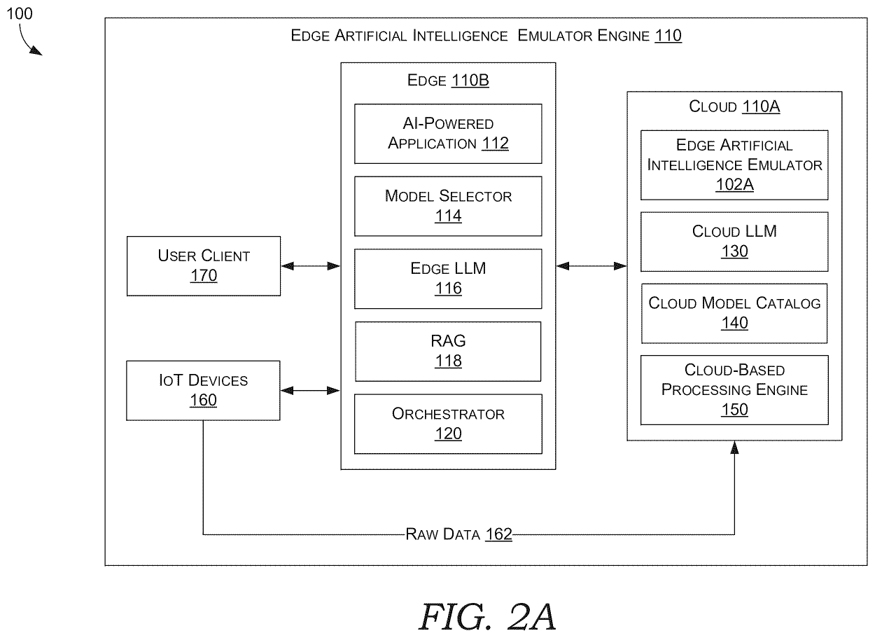

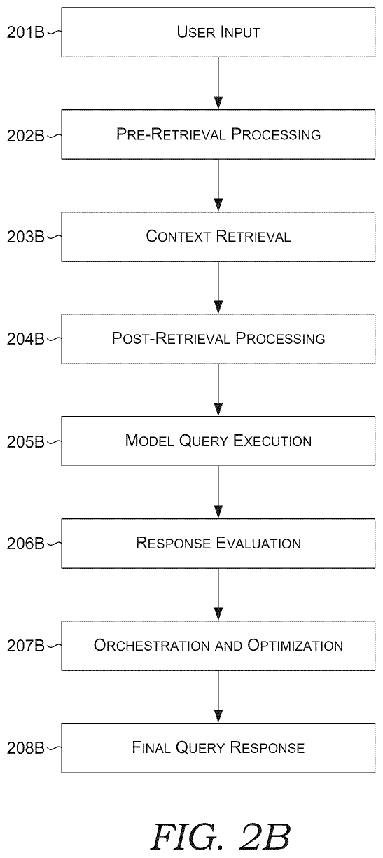

With reference to FIG. 2A, FIG. 2A, illustrates a cloud computing system 100, artificial intelligence (AI) system 100A, edge artificial intelligence emulator engine 110, cloud 110A and edge 110B, AI-powered application 112, model selector 114, edge LLM 116, RAG 118, orchestrator 120, edge artificial intelligence emulator 102A, cloud LLM 130, cloud model catalog 104, and cloud-based processing engine 150, IoT devices 160 with raw data 162, and user client 170.

The cloud computing system 100 supports the edge artificial intelligence emulator engine 110—a system designed to facilitate AI-driven query resolution, model selection, and inference execution by integrating edge-based and cloud-based components. edge artificial intelligence emulator engine 110 enables an optimized, scalable, and efficient hybrid AI processing architecture, allowing seamless coordination between edge devices, cloud resources, and IoT ecosystems.

The edge artificial intelligence emulator engine 110 supports two primary processing environments: edge 110B and cloud 110A. The edge 110B hosts the AI-Powered Application 112 that interacts with local processing components. Edge 110B incorporates a model selector 114, supports determining selecting a model for a given query that can be processed locally via an edge LLM 116 or offloaded to cloud infrastructure. The RAG 118 module enhances query responses by fetching additional relevant context before inference. The orchestrator 120 serves as the real-time decision-making module, dynamically optimizing the query execution path by balancing accuracy, latency, and cost considerations.

The cloud 110A represents the centralized AI inference and resource management layer, housing the edge artificial intelligence emulator 102A, which supports offline benchmarking and performance evaluation of different query resolution paths. The cloud LLM 130 provides access to large-scale AI models for complex or resource-intensive queries. The cloud model catalog 140 stores various pre-trained models, allowing the model selector 114 to dynamically choose the most suitable one. The cloud-based processing engine 150 manages computational workloads for cloud-executed inference requests, ensuring optimal query execution.

The user client 170 interacts with the edge AI system, submitting queries that are processed either locally or through cloud services, depending on system constraints and resource availability. IoT devices 160, such as cameras, sensors, and embedded systems, provide real-time environmental raw data 162 that can be utilized to refine AI inference accuracy. By integrating edge and cloud AI processing, the edge artificial intelligence emulator engine 110 optimizes query resolution efficiency, minimizes latency, and reduces cloud processing costs while ensuring high accuracy and scalability in real-world applications.

By way of illustration, edge artificial intelligence engine optimizes query resolution in a hybrid edge-cloud computing environment simulating interactions based on a custom artificial intelligence system configuration profile, generating an orchestrator, and producing optimal query resolution paths that balance accuracy, cost, and latency.

The edge artificial intelligence emulator functions as an offline benchmarking and evaluation system that accesses an input defining the custom artificial intelligence system configuration profile. The custom artificial intelligence system configuration profile contains user preferences, domain context, and device configuration tailored to the AI system's specific use case. The edge artificial intelligence emulator simulates interactions between edge and cloud computing environments, utilizing edge-cloud caching and remote API calls to evaluate different execution pathways. Simulating interactions allows the edge artificial intelligence emulator to precompute optimal query resolution strategies, ensuring that once deployed, the orchestrator can execute queries efficiently in real time.

The orchestrator, generated based on the emulator's simulations, is responsible for executing AI queries dynamically by selecting the most optimal query resolution path. This is achieved through a lightweight path selection mechanism that leverages unsupervised strategies to analyze data from the edge artificial intelligence emulator. The orchestrator determines query resolution by analyzing a plurality of optional query resolution path stages, including:
User Input Stage—Where a query is received from an AI-powered assistant, user client, or IoT device.
Pre-Retrieval Processing Stage—Where query alterations or enhancements (e.g., reformatting for retrieval optimization) are applied.
Context Retrieval Stage—Where the AI system fetches information from vector databases, knowledge graphs, or indexed embeddings to enrich query context.
Post-Retrieval Processing Stage—Where additional ranking, filtering, or verification techniques are applied to improve response relevance.
Model Query Stage—Where the Orchestrator selects an appropriate AI model, deciding between an Edge LLM for low-latency execution or a Cloud LLM for high-complexity tasks.
Query Response Stage—Where the final response is generated and returned to the client.

For example, in a customer support system, a user query such as “What is my current account balance?” may go through the orchestrator, which checks the custom artificial configuration profile and user preferences to determine the most optimal resolution path. The orchestrator might decide to:

Use edge processing if the data is cached locally, allowing for an instant response with minimal latency.

Use cloud processing if the data requires a secure banking API request, triggering a remote API call to fetch real-time information.

Additionally, the edge artificial intelligence emulator generates a performance trade-off profile, providing a quantitative evaluation of different query resolution pathways and their impact on accuracy, cost, and latency. The performance trade-off profile is used to train the orchestrator to make better real-time routing decisions, improving AI inference efficiency over time. The edge artificial intelligence emulator engine also accounts for data input from IoT devices, where raw data from sensors, cameras, or logs are sent to the cloud. Ingesting IoT data in a timely manner enables AI systems to incorporate real-time environmental inputs into their reasoning. As a result, responses are more contextually accurate and better aligned with the current state of affairs.

In this way, the edge artificial intelligence emulator ensures that AI queries are executed intelligently and efficiently by leveraging precomputed emulator insights, real-time orchestrator decision-making, and hybrid edge-cloud processing capabilities, optimizing AI inference for diverse applications.

For clarity and efficient reference, a glossary of key terms and concepts pertinent to the technical solution is provided below.
Edge Artificial Intelligence Emulator or Edge Artificial Intelligence Emulator Engine—A system that simulates AI-driven query resolution strategies in a hybrid edge-cloud computing environment before live deployment, ensuring optimal execution paths. Also refers to a specialized AI simulation framework that evaluates different execution strategies, leveraging databases, retrievers, frameworks, and evaluators to benchmark performance.
Orchestrator—A lightweight path selection mechanism that determines the optimal query resolution path based on unsupervised strategies, performance trade-offs, and AI emulator insights.
Custom Artificial Intelligence System Configuration Profile—A configuration file defining system behavior, including user preferences, domain context, and device configuration, to tailor AI query resolution.
Hybrid Edge-Cloud Computing Environment—A distributed AI processing architecture where an edge computing environment handles low-latency requests, while a cloud computing environment manages complex queries and model-intensive tasks.
Query Resolution Path—The end-to-end execution pipeline for processing AI queries, structured into multiple stages such as:
User Input Stage—Receiving the AI query from a client device.
Pre-Retrieval Processing Stage—Enhancing or reformatting the query to improve retrieval effectiveness.
Context Retrieval Stage—Searching local databases or vectorized embeddings to fetch relevant knowledge.
Post-Retrieval Processing Stage—Refining retrieved context through re-ranking or filtering mechanisms.
Model Query Stage—Selecting the appropriate Edge LLM or Cloud LLM for inference.
Query Response Stage—Delivering the final AI-generated response to the user.

Edge-Cloud Caching Operations—A mechanism that optimizes query execution by storing frequently used responses at the edge, reducing redundant cloud inference requests.
Remote API Calls—Cloud-based interactions where the AI system communicates with external services to fetch real-time data, enhance retrieval, or execute advanced processing.
Performance Trade-Off Profile—A quantitative evaluation of query resolution pathways, balancing accuracy, cost, and latency to determine the most efficient AI execution route.
Unsupervised Strategies—Techniques used within the orchestrator and emulator to analyze AI system behavior, including similarity estimation, clustering, and heuristic optimization, to automate path selection.
AI-Powered Assistant—The application layer of the AI system, interacting with users via speech, text, or multimodal interfaces, while routing queries based on edge-cloud resource availability.
Client Query Processing—The mechanism through which a client device communicates an AI query, which is then processed through the orchestrator and routed to the appropriate execution environment.
Raw Data Communication—The process of ingesting and processing external data from IoT devices, sensors, or logs to refine AI inference, improve context retrieval, and enhance real-time responses.
Cloud Model Catalog—A repository of pre-trained AI models in the cloud, allowing dynamic selection of models based on query requirements, latency constraints, and accuracy thresholds.
Cloud-Based Processing Engine—A compute-intensive AI execution layer that handles complex AI inference tasks, leveraging scalable infrastructure for high-demand processing.
Routing Execution of Queries—The orchestrator's ability to dynamically select edge or cloud environments for processing based on system load, resource constraints, and query complexity.
AI System Deployment and Adaptation—The continuous improvement cycle where AI query resolution paths are optimized over time, integrating feedback loops, real-time system monitoring, and performance evaluations.

With reference to FIG. 2B, FIG. 2B a flow chart 200B associated with providing an edge artificial intelligence emulation using an edge artificial intelligence emulator engine in accordance with embodiments described herein. The technical solution of the edge artificial intelligence emulator engine can be explained by way of steps and an example scenario.
At step 201B—User Input: The process begins with user input, where the edge artificial intelligence emulator engine receives a query along with user-defined constraints, including preferences for accuracy, computational cost, and response latency. Additionally, the emulator ingests supplementary inputs such as sample prompts, domain-specific context, and device configurations, which define hardware limitations and network conditions that influence query resolution.
At step 202B—Pre-retrieval processing: In Pre-Retrieval Processing, the system enhances the query before retrieving relevant context. This may involve query alteration, where linguistic modifications improve retrieval effectiveness, or XoT prompting, which reformulates queries to align with model-specific capabilities. Edge-cloud caching mechanisms also come into play, optimizing storage and retrieval decisions to balance computational efficiency.
At step 203—Context Retrieval: The Context Retrieval phase involves fetching relevant data from vector-based databases, ensuring that the system retrieves high-quality information to support inference. This step uses techniques such as Extended Retrieval, HyDE (Hypothetical Document Embeddings), Reciprocal Rank Fusion, and Raptor, each designed to maximize the relevance and precision of retrieved content. The system dynamically selects the best retrieval approach based on domain knowledge, historical query performance, and user-defined constraints.
At step 204B—Post-Retrieval Processing: Following retrieval, the Post-Retrieval Processing step further refines the context before passing it to the inference model. Techniques such as Corrective-RAG (Retrieval-Augmented Generation), FLARE, Document Reranking, and Self-Reflection RAG enhance the quality of the retrieved documents by filtering irrelevant information, prioritizing high-confidence sources, and adjusting content based on query intent. This ensures that the language model processes only highly relevant, structured information, leading to more accurate responses.
At step 205B—Model Query Execution: During Model Query Execution, the processing engine selects the most appropriate inference model based on the nature of the query and system constraints. If the query can be handled with low latency on edge devices, the system uses Ollama for on-device processing. If higher computational resources are required, inference is offloaded to cloud-based models such as Azure GPT-4 or OpenAI. The emulator intelligently switches between edge and cloud inference in real time, leveraging hybrid execution paths when necessary.
At step 206B—Response Evaluation: Once the model generates a response, Response Evaluation ensures its quality by assessing accuracy, fluency, coherence, and relevance. The system employs DeepEval and other structured evaluation frameworks to score the response. If the output fails to meet quality thresholds, the emulator can reprocess the query using an alternative retrieval method, model selection, or inference configuration, ensuring that suboptimal responses are refined before being delivered.
At step 207B—Orchestration and Optimization: In the Orchestration & Optimization step, the system dynamically selects the best query execution path based on real-time accuracy, cost, and latency trade-offs. The orchestrator continuously monitors system performance and adapts execution strategies to balance efficiency with user-defined constraints. The performance trade-off profile generated in this step provides quantitative insights into various execution configurations, allowing users to fine-tune their AI deployment.
At step 208B—Final Query Response: Finally, in the Final Query Response step, the optimized output is presented to the user. The system may also provide additional metadata, such as processing time, resource utilization, and trade-off considerations, enabling further refinements. This structured pipeline ensures that the Edge Copilot Emulator optimizes AI inference dynamically, allowing organizations to maximize performance, efficiency, and scalability across edge-cloud environments.

With reference to the above steps, an example implementation can be employed to explain the functionality of the technical solution. For example, a large retail chain deploys AI-powered kiosks and a mobile app to provide instant customer support for product inquiries, inventory checks, and recommendations. These kiosks and apps must process user queries quickly and accurately, but they face constraints such as limited on-device compute power, variable network conditions, and cost considerations for cloud-based processing. The retailer uses the Edge Copilot Emulator to dynamically optimize AI inference based on these constraints.
Step 1: User Input—A customer at a self-service kiosk submits a query: “Do you have wireless noise-canceling headphones under $200?” At the same time, a user on the mobile app submits a similar query, but from a low-bandwidth network location.

The emulator collects:
User preferences: The retailer prioritizes fast responses with high accuracy but wants to minimize cloud costs where possible.
Device constraints: The kiosk has limited GPU power, while the mobile app depends on network stability.
Domain information: The retailer's product catalog, past user queries, and sales trends are available in vector databases.
Step 2: Pre-Retrieval Processing-The emulator enhances the query by adding synonyms like “wireless over-ear headphones” to improve search accuracy. The edge artificial intelligence emulator engine checks edge-cloud caching to see if a recent response exists for similar queries.
Step 3: Context Retrieval: The emulator queries vector databases to retrieve relevant product listings, user reviews, and current stock levels. It applies extended retrieval and reciprocal rank fusion to prioritize highly relevant and frequently purchased items.
Step 4: Post-Retrieval Processing-The retrieved data is refined using FLARE and Document Reranking to eliminate irrelevant results. If any results are ambiguous, Self-Reflection RAG analyzes prior user interactions to re-rank the best matches.
Step 5: Model Query Execution-For the kiosk: Since the query is straightforward, the system selects Ollama (an edge-based model) to generate the response locally with minimal latency. For the mobile user: Due to network instability, the emulator splits execution, processing part of the query locally while offloading complex reasoning to Azure GPT-4 via a remote API call.
Step 6: Response Evaluation-The generated responses are scored based on accuracy, coherence, and fluency using DeepEval. If a response is incomplete or unclear, the system re-runs retrieval or model selection before presenting the answer.
Step 7: Orchestration & Optimization-The orchestrator compares latency vs. cost vs. accuracy trade-offs and updates the performance trade-off profile. The best-performing execution path is logged for future optimizations, reducing redundant cloud calls.
Step 8: Final Query Response-Kiosk Output: “Yes! We have 3 models in stock that match your criteria. The most popular option is the Sony WH-1000XM4 for $198. Would you like to see details?” Mobile App Output: “Yes! Here are the top noise-canceling wireless headphones under $200. Due to network conditions, some results may be delayed.” The app prefetches stock details asynchronously for a smoother experience.

As such, the kiosk response is near-instant since it used local inference. The mobile app balances cloud accuracy with edge efficiency, ensuring a smooth user experience despite network limitations. The retailer saves cloud processing costs by processing simpler queries on edge devices while offloading complex reasoning selectively. The orchestrator continuously refines execution strategies, improving response efficiency over time. By leveraging the emulator, the retailer optimizes AI-driven customer interactions, ensuring fast, cost-effective, and scalable support across both in-store kiosks and mobile applications.

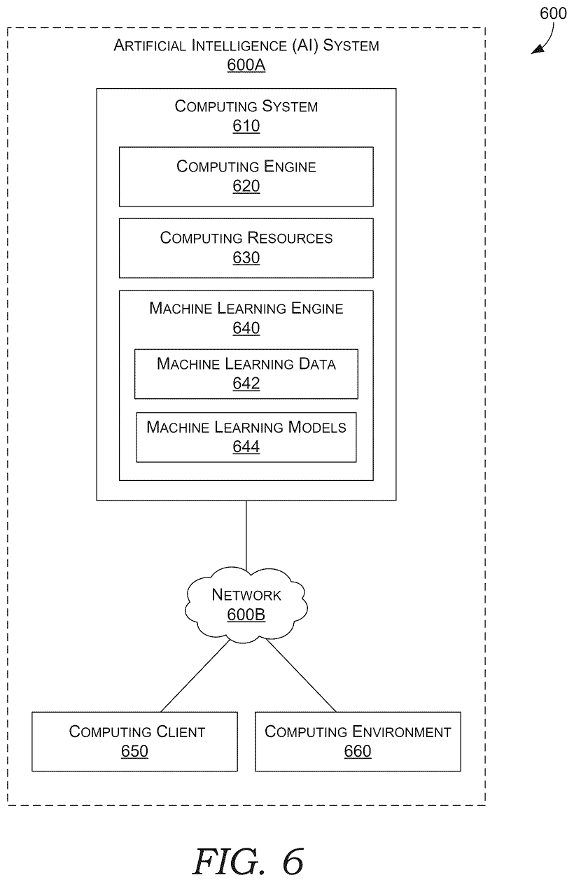

Aspects of the technical solution have been described by way of examples and with reference to FIG. 1A-1E, 2A and 2B. FIG. 2A is a block diagram of an exemplary technical solution environment, based on example environments described with reference to FIGS. 6, 7 and 8 for use in implementing embodiments of the technical solution are shown. Generally, the technical solution environment includes a technical solution system suitable for providing the example cloud computing system 100 in which methods of the present disclosure may be employed. In particular, FIG. 2A illustrates a high-level architecture of the cloud computing system 100 in accordance with implementations of the present disclosure, among other engines, managers, generators, selectors, or components not shown (collectively referred to herein as “components”).

### Example Methods

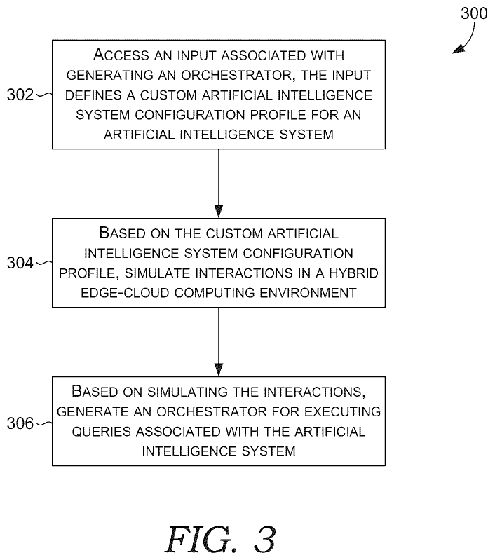

With reference to FIGS. 3, 4, and 5, flow diagrams are provided illustrating methods for providing edge artificial intelligence emulation using an edge artificial intelligence emulator engine in an artificial intelligence system. The methods may be performed using the artificial intelligence system described herein. In embodiments, one or more computer-storage media having computer-executable or computer-useable instructions embodied thereon that, when executed, by one or more processors can cause the one or more processors to perform the methods (e.g., computer-implemented method) in the artificial intelligence system (e.g., a computerized system).

Turning to FIG. 3, a flow diagram is provided that illustrates a method 300 for providing edge artificial intelligence emulation using an edge artificial intelligence emulator engine in an artificial intelligence system. At block 302, access, at an edge artificial intelligence emulator, an input associated with generating an orchestrator, wherein the input defines a custom artificial intelligence system configuration profile for an artificial intelligence system. At block 304, based on the custom artificial intelligence system configuration profile, simulate interactions of a hybrid edge-cloud computing environment, wherein the interactions are associated with the functionality of the artificial intelligence system. At block 306, based on simulating the interactions, generate an orchestrator for executing queries associated with the artificial intelligence system, wherein the orchestrator supports generating optimal query resolution paths for the queries.

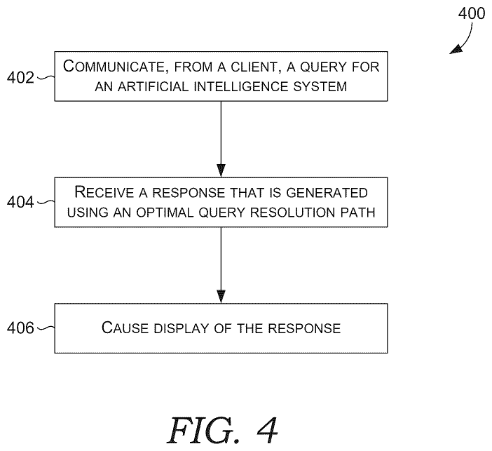

Turning to FIG. 4, a flow diagram is provided that illustrates a method 400 for providing edge artificial intelligence emulation using an edge artificial intelligence emulator engine in an artificial intelligence system. At block 402, communicate, from a client, a query for an artificial intelligence system. At block 404, based on communicating the query, receive a response that is generated using an optimal query resolution path, wherein the optimal query resolution is determined using an orchestrator, wherein the orchestrator is generated using an edge artificial intelligence emulator and a custom artificial intelligence system configuration profile. At block 406, cause display of the response.

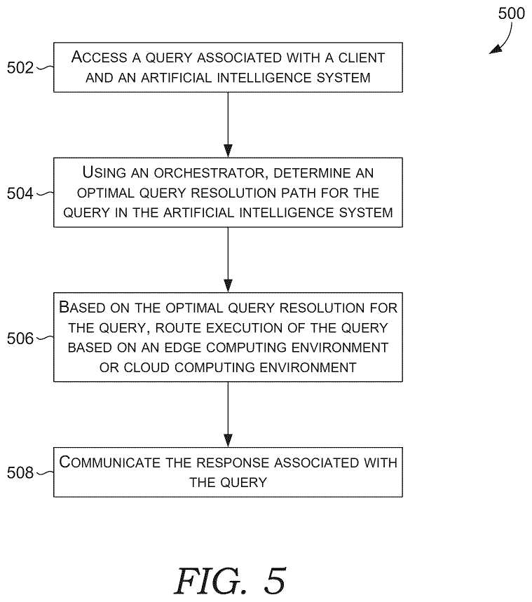

Turning to FIG. 5, a flow diagram is provided that illustrates a method 500 for providing edge artificial intelligence emulation using an edge artificial intelligence emulator engine in an artificial intelligence system. At block 502, access a query associated with a client and an artificial intelligence system. At block 504, using an orchestrator, determine an optimal query resolution path for the query in the artificial intelligence system, wherein the orchestrator is generated using an edge artificial intelligence emulator and a custom artificial intelligence system configuration profile. At block 506, based on the optimal query resolution path for the query, route execution of the query based on an edge computing environment or a cloud computing environment. At block 508, based on routing execution of the query, access a response to the query. At block 510, communicate the response associated with the query.

### Technical Improvement

Embodiments of the present techniques have been described with reference to several inventive features (e.g., operations, systems, engines, and components) associated with an artificial intelligence system. Inventive features described include operations, interfaces, data structures, and arrangements of computing resources associated with providing the functionality described herein relative with reference to an edge artificial intelligence emulator engine. Functionality of the embodiments of the present invention have further been described, by way of an implementation and anecdotal examples-to demonstrate that the operations for providing the edge artificial intelligence emulator engine as a solution to a specific problem in artificial systems technology to improve computing operations in artificial intelligence systems.

By way of illustration, edge artificial intelligence emulator engine enables efficient query resolution and AI-driven orchestration in a hybrid edge-cloud environment. The edge artificial intelligence emulator performs offline simulations based on a custom artificial intelligence system configuration profile, testing different query execution paths. By evaluating user preferences, domain context, and device configurations, it benchmarks accuracy, cost, and latency trade-offs, ensuring optimal performance when an orchestrator is deployed. The orchestrator, created using emulator insights, dynamically determines the best query resolution path based on real-time system constraints. It selects between edge or cloud inference, applies retrieval strategies, and optimizes execution routes. The edge artificial intelligence emulator engine routes queries through defined resolution stages, such as context retrieval, pre/post-processing, and inference execution, using an adaptive decision-making framework that ensures queries are processed cost-effectively and with minimal latency.

Advantageously, the edge artificial intelligence emulator conducts offline benchmarking, allowing the edge artificial intelligence emulator engine to evaluate multiple query resolution strategies before live deployment. This eliminates unnecessary trial-and-error in real-time execution, ensuring pre-validated accuracy, latency, and cost trade-offs, which improves system reliability and efficiency.

The orchestrator, generated from emulator insights, leverages unsupervised optimization techniques to dynamically adjust query paths based on real-time conditions. This eliminates static rule-based processing, allowing context-aware AI inference that scales across different edge-cloud configurations.

The query resolution strategy ensures efficient use of edge and cloud resources by minimizing redundant cloud processing through edge caching. This reduces computational load, optimizes power consumption, and enhances response speed, making the edge artificial intelligence emulator engine scalable for real-time AI deployments.

### Additional Support for Detailed Description

### Example Artificial Intelligence (AI) System in a Computing Environment

Referring now to FIG. 6, FIG. 6 illustrates a computing environment in which implementations of the present disclosure may be employed. In particular, FIG. 6 shows a high level architecture of an example cloud computing platform 600, artificial intelligence (AI) system 600A, and computing system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing platform 600 provides computing system resources for different types of managed computing environments. For example, the cloud computing platform supports delivery of computing services-including compute, servers, storage, databases, networking, and intelligence. The components of cloud computing platform 600 may communicate with each other over a network 600B which may include, without limitation, one or more local area networks (LANs) and/or wide area networks (WANs).

The AI system 600A provides a specialized infrastructure designed to support the computational demands of artificial intelligence (AI) workloads, including both training and inference tasks. The AI backend network systems 600A consists of interconnected components that facilitate the efficient processing, communication, and management of data within a distributed computing environment. Operations include data processing, handling input data, intermediate results, and output data, alongside complex computations for AI tasks, communication facilitating seamless interaction among components, and resource management overseeing optimal utilization of compute nodes, accelerators (e.g., GPUs, TPUs), memory, and storage. Interfaces encompass network interfaces enabling high-speed communication between nodes, APIs providing standardized interaction methods for developers, and management interfaces for system monitoring and administration. Data support functionalities include storage, data movement, transformation, and replication with backup mechanisms, ensuring data durability and reliability. In this way, the AI backend network system serves as the backbone infrastructure for AI workloads, facilitating efficient and scalable AI processing across distributed computing environments through its comprehensive operations, interfaces, and data management functionalities.

The cloud computing platform 600 provides the foundational infrastructure and resources for deploying and managing computing workloads, including AI. AI system 600A includes specialized infrastructures tailored for supporting the unique computational demands of AI workloads. The relationship between the two involves resource provisioning, integration, orchestration, and data processing, enabling organizations to leverage cloud-based resources effectively for AI development and deployment.

The computing system 610 provides computing functionality for computing environments. For example, the computing system 610 is a platform or framework that leverages advanced technologies such as artificial intelligence (AI), machine learning (ML), data mining, and big data analytics to extract actionable insights and knowledge from large and complex datasets. In this way, the computing system 610 provides a computing environment that enables organizations to make informed decisions and optimize operations.

The computing system 610 includes a computing engine 620 that is a computing environment that supports executing computational tasks associated with the computing system 610. The computing engine 620 can be a hardware or software component that performs computational operations, such as, mathematical calculations, data processing, and algorithm execution. The computing system 610 integrates computing resources 630 into computing system 610 to effectively provide computing functionality in a computing environment.

The computing resources 630 refer to computing elements (e.g., components, capability, or entities) that collectively enable the computing engine 620 operations. The computing resources 630 encompass a spectrum of computing elements, beginning with the diverse operations the computing resources 630 can perform, ranging from complex computations to data manipulations. Interfaces, an integral part of the computing resources 630, provide the means for both user interaction and seamless integration with external systems, ensuring a dynamic and interactive computing experience. The data facet of the data computing resources 630 involves various types: input data, which is the information provided for processing; processing data, representing the data manipulated during computational tasks; and output data, the results generated by the computing engine 620. In this way, the computing resources 630 support the broader computing engine 620 and computing system 610.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 640 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The computing client 650 supports access to computing system 610. The computing client 650 can be provided as a user client or an administrator client to support user and administrator functionality associated with the computing environment 660, computing engine 620, or computing system 610. The computing client 650 can also support accessing computing visualizations and causing display of the computing visualization. The computing client 650 can include a computing engine client that supports receiving computing information associated computing engine 620 output from the computing system 610 and causing presentation of the computing information. The computing information can specifically include computing visualizations associated with the computing engine 620 output.

Computing environment 660 is a computing environment that is integrated into the computing system 610. The computing environment 660 is characterized by an infrastructure, where data from various sources within the ecosystem, including servers, networks, applications, sensors, and user interactions, can be aggregated and processed by the computing system 610 to perform computing tasks. The computing environment 660 can be associated with middleware and integration layers facilitate seamless data flow, while computing infrastructure, encompassing cloud-based resources, distributed computing frameworks, and optimized storage systems, supports functionality associated with the computing.

### Example Distributed Computing System Environment

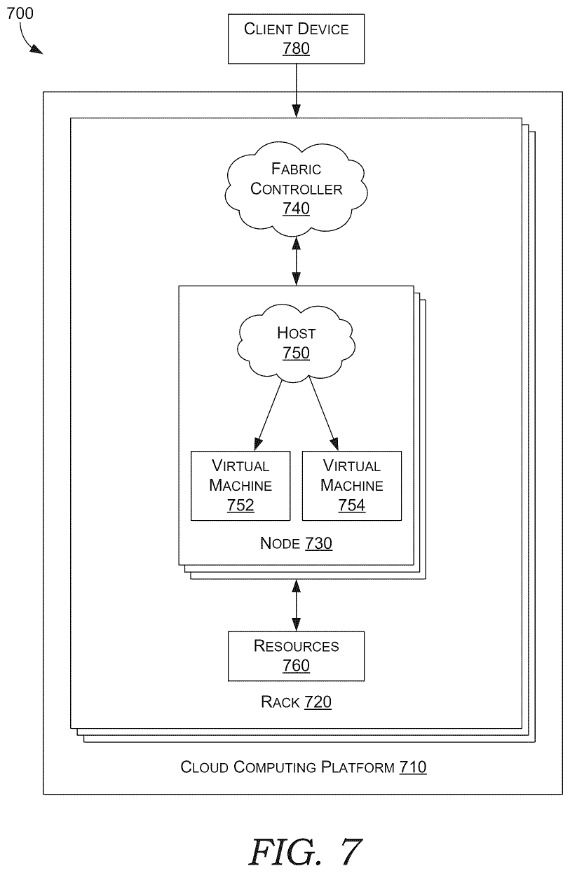

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

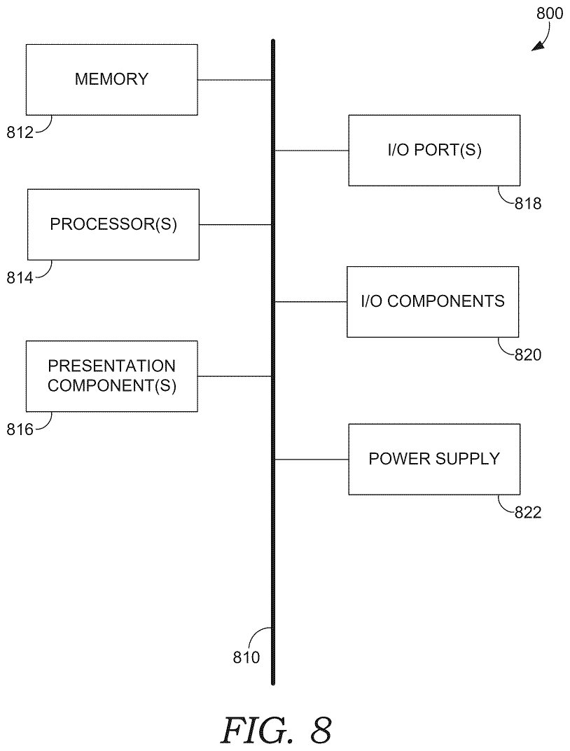

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors;
computer memory storing computer-useable instructions that, when used by the one or more computer processors, cause the one or more computer processors to perform operations, the operations comprising:
accessing, at an edge artificial intelligence emulator, an input associated with generating an orchestrator, wherein the input defines a custom artificial intelligence system configuration profile for an artificial intelligence system;
based on the custom artificial intelligence system configuration profile, simulating interactions of a hybrid edge-cloud computing environment, wherein the interactions are associated with functionality of the artificial intelligence system; and
based on simulating the interactions, generating the orchestrator for executing queries associated with the artificial intelligence system, wherein the orchestrator supports generating optimal query resolution paths for the queries.

2. The system of claim 1, wherein the custom artificial intelligence system configuration profile comprises user preferences, domain context, and device configuration associated with the artificial intelligence system, wherein the artificial intelligence system is an AI-powered assistant that operates via the hybrid edge-cloud computing environment.

3. The system of claim 1, wherein the edge artificial intelligence emulator is built on processors, databases, retrievers, frameworks, and evaluators that support simulating the interactions, wherein simulating the interactions is based on edge-cloud caching operations and remote Application Programming Interface (API) calls between an edge computing environment and a cloud computing environment.

4. The system of claim 1, the operations further comprising generating a performance trade-off profile, wherein the performance trade-off profile provides a quantitative evaluation of different query resolution pathways, highlighting trade-offs in accuracy, cost, and latency.

5. The system of claim 1, the operations further comprising deploying the orchestrator to cause support of the artificial intelligence system, wherein the orchestrator generates optimal query resolution paths for queries.

6. The system of claim 1, wherein the orchestrator comprises a lightweight path selection mechanism that leverages the edge artificial intelligence emulator associated with unsupervised strategies that are used to analyze edge artificial intelligence emulator data.

7. The system of claim 1, wherein the orchestrator determines optimal query resolution paths for the queries is based on a plurality of optional query resolution path stages comprising: a user input stage, a pre-retrieval processing stage, a context retrieval stage, a post-retrieval processing stage, a model query stage, and a query response stage.

8. One or more computer-storage media having computer-executable instructions embodied thereon that, when executed by a computing system having a processor and memory, cause the processor to perform operations, the operations comprising:
communicating, from a client, a query for an artificial intelligence system;
based on communicating the query, receiving a response that is generated using an optimal query resolution path, wherein the optimal query resolution is determined using an orchestrator, wherein the orchestrator is generated using an edge artificial intelligence emulator and a custom artificial intelligence system configuration profile; and
causing display of the response.

9. The media of claim 8, wherein determining the optimal query resolution path for the query is associated with a plurality of optional query resolution path stages comprising: a user input stage, a pre-retrieval processing stage, a context retrieval stage, a post-retrieval processing stage, a model query stage, and a query response stage.

10. The media of claim 8, wherein the custom artificial intelligence system configuration profile comprises user preferences, domain context, and device configuration associated with the artificial intelligence system.

11. The media of claim 8, wherein the optimal query resolution is generated based in part on the custom artificial intelligence system configuration profile for the artificial intelligence system.

12. The media of claim 8, wherein the orchestrator comprises a lightweight path selection mechanism that leverages the edge artificial intelligence emulator associated with unsupervised strategies that are used to analyze edge artificial intelligence emulator data.

13. The media of claim 8, wherein the artificial intelligence system is an AI-powered assistant that is integrated into a hybrid edge-cloud computing environment.

14. The media of claim 8, wherein the response is generated based on employing the orchestrator to route execution of the query based on an edge computing environment or a cloud computing environment.

15. A computer-implemented method, the method comprising:
accessing a query associated with a client and an artificial intelligence system;
using an orchestrator, determining an optimal query resolution path for the query in the artificial intelligence system, wherein the orchestrator is generated using an edge artificial intelligence emulator and a custom artificial intelligence system configuration profile;
based on the optimal query resolution path for the query, routing execution of the query based on an edge computing environment or a cloud computing environment;
based on routing execution of the query, accessing a response to the query; and
communicating the response associated with the query.

16. The method of claim 15, wherein determining the optimal query resolution path for the query is associated with a plurality of optional query resolution path stages comprising: a user input stage, a pre-retrieval processing stage, a context retrieval stage, a post-retrieval processing stage, a model query stage, and a query response stage.

17. The method of claim 15, wherein the custom artificial intelligence system configuration profile comprises user preferences, domain context, and device configuration associated with the artificial intelligence system.

18. The method of claim 15, wherein the optimal query resolution is generated based in part on the custom artificial intelligence system configuration profile for the artificial intelligence system.

19. The method of claim 15, wherein the orchestrator comprises a lightweight path selection mechanism that leverages the edge artificial intelligence emulator associated with unsupervised strategies that are used to analyze edge artificial intelligence emulator data.

20. The method of claim 15, wherein the cloud computing environment communicates with one or more additional devices that communicate raw data associated with generating responses to queries.
